(19) United States
(12) Patent Application Publication
(10) Pub. No.: US 2026/0050995 A1
(43) Pub. Date: Feb. 19, 2026

(54) SYSTEM FOR CALCULATING DRIVER DRIVING SCORE, AND DRIVING SCORE CALCULATION METHOD FOR SYSTEM

(71) Applicant: LG ELECTRONICS INC., Seoul (KR)

(72) Inventors: Kihyeon KIM, Seoul (KR); Yonghwan LEE, Seoul (KR); Jongyeop LEE, Seoul (KR); Ahyoung SHIN, Seoul (KR); Joonghang KIM, Seoul (KR)

(73) Assignee: LG ELECTRONICS INC., Seoul (KR)

(21) Appl. No.: 19/103,516

(22) PCT Filed: Feb. 8, 2023
(86) PCT No.: PCT/KR2023/001776

§ 371 Date: Feb. 12, 2025

(30) Foreign Application Priority Data
Sep. 8, 2022 (KR) 10-2022-0114216

(51) Int. Cl. G06Q 40/08

(52) U.S. Cl. CPC G06Q 40/08221

(57) ABSTRACT

The present invention relates to a method by which a network-based data warehouse system calculates a driver driving score, which is a basis for an insurance rating or insurance payment of a driver, the method comprising the steps of: receiving sensor data detected by a plurality of sensors provided in a vehicle; determining at least one risk event preset on the basis of the received sensor data; determining, on the basis of context data included in the received sensor data, at least one context matched to the at least one determined risk event; rescoring, on the basis of the determined at least one context, an event score corresponding to each of the determined risk events; and calculating a driving score related to driving of the vehicle on the basis of the rescored event scores of the respective risk events.

### TECHNICAL FIELD

The present disclosure relates to a system for calculating a driver's driving score, which is a basis for an insurance rating or insurance payment of a driver.

### BACKGROUND ART

Typically, when paying an insurance amount to a driver or determining the driver's insurance rating, whether the driver usually drives safely is an important factor in paying the insurance amount or determining the insurance rating.

In addition, with the advancement of technology, it is now possible to detect a driver's driving action according to a vehicle driving condition from a vehicle in motion, and a method has been introduced to calculate how safely the driver usually drives as a score, that is, a driving score. The driving score is calculated based on a driving condition of the vehicle according to the driver's driving action, and the more he or she avoids a dangerous driving condition such as rapid deceleration, rapid acceleration, speeding, and impact, that is, a driving action in response to a risk event, the lower the subtraction factor is, which may lead to a higher driving score. That is, the more safely a driver usually drives, the higher his or her driving score may be calculated.

As such, the driving score is a basis for evaluating how safely a driver usually drives, and therefore may be used by an insurance company or the like to determine an insurance premium or insurance amount, or to determine a driver's insurance rating. However, current driving score determination methods determine whether the preset risk event (rapid acceleration, rapid deceleration, speeding, impact, etc.) has occurred based on sensor data collected from a vehicle, and calculate a driving score by reflecting a score (weight) based on an insurance company policy corresponding to each risk event for risk events occurring over a predetermined period of time, and thus there is a problem in that it is calculated uniformly for each risk event and does not reflect different levels of risk according to a driver's driving situation or the like.

As such, a method of determining whether a risk event has occurred without considering a driver's driving situation at all, and calculating a driving score uniformly for a risk event that has occurred may result in a situation where a driving action for safety, such as a driving action that is driven for safety (e.g., rapid deceleration due to a cut-in occurred), is rather regarded as a driving action in response to a risk event, and thus the driving score is subtracted. In addition, there is a problem in that a driving score calculated does not accurately reflect a driver's driving aspect, such as reflecting the same weight for risk events in a case where the driver drives alone and in a case where a passenger is on board, although a level of risk may be much higher in a case where there is a passenger such as a family member on board than in a case where the driver drives alone.

Accordingly, there is a problem in that drivers are increasingly dissatisfied with a driving score that does not accurately reflect a driving aspect, and there is also a problem in that an insurance amount, an insurance premium, or an insurance rating is unfairly determined based on a driving score that is calculated unilaterally without considering a driving situation.

In addition, there is a problem in that it is difficult for a driver to empathize with a driving score that does not accurately reflect the driver's driving aspect, and it is difficult to provide feedback to improve the driver's driving habit based on the driving score.

### DISCLOSURE OF INVENTION

### Technical Problem

The present disclosure aims to solve the foregoing problems and other problems, and an aspect of the present disclosure is to provide a driving score calculation system that detects contexts of driving situations for various risk events occurring during driving, and dynamically reflects event scores for risk events for the detected contexts so as to calculate a driving score that more accurately reflects a driver's actual driving aspect, and a driving score calculation method for the system.

In addition, another aspect of the present disclosure is to provide a system capable of calculating a driver's driving score that more accurately reflects the driver's driving style and driving situation and providing an analysis result thereof so as to provide feedback that can improve the driver's driving habit.

### Solution to Problem

In order to achieve the foregoing and other objectives, a method of calculating, by a network-based data warehouse system, a driver's driving score based on sensor data items detected from a vehicle may include receiving sensor data items detected from a plurality of sensors provided in the vehicle, determining at least one preset risk event based on the received sensor data items, determining at least one context matching each of the at least one determined risk event based on context data items included in the received sensor data items, rescoring an event score corresponding to each of the determined risk events based on the at least one determined context, and calculating a driving score related to the driving of the vehicle based on the rescored event scores of the respective risk events.

In one embodiment, the calculating of the driving score may include detecting data related to a driver's driving action from the sensor data items, detecting the driver's driving characteristic from the detected driving action data, classifying the driver's situational driving style based on the detected driving characteristic and the driver's driving situation, and reflecting the rescored event scores corresponding to the respective determined risk events to a base driving score on a trip-by-trip basis calculated according to the classified driver's situational driving style to calculate a moving score on the trip-by-trip basis.

In one embodiment, the determining of the at least one risk event may include detecting sensor data items that satisfy any one of preset risk event occurrence conditions from among the sensor data items, determining a time section in which the sensor data items are detected as an event zone, and determining a risk event corresponding to the event zone based on the sensor data items of the each determined event zone and a risk event occurrence condition that satisfies the sensor data items.

In one embodiment, the determining of the at least one context may include extracting context data items related to a driving situation of the vehicle from respective time sections of the sensor data corresponding to each event zone and a time section including predetermined periods of time before and after the each event zone, and determining a context representing a driving situation of the vehicle matching the each event zone based on the extracted context data items.

In one embodiment, the classifying of the driver's situational driving style may include detecting the driver's driving characteristic from the remaining driving action data items excluding the driving action data corresponding to the determined risk event from among the sensor data items.

In one embodiment, the driver's driving characteristic may include at least one of a speed characteristic according to an average speed of the vehicle, an area-specific driving characteristic according to an area-specific speed of a path on which the vehicle drives, and a driving stability characteristic according to a speed deviation.

In one embodiment, the driver's driving situation may include at least one of a driving history to a destination on a driving path, a driving time, whether there is a passenger, whether the driver is driving his or her own vehicle, and a distance to the destination.

In one embodiment, the context data may be data collected from at least one sensor that detects a situation inside and outside the vehicle, the context data including at least one of detection values of advanced driver assistance systems (ADAS), an image of a camera sensing an image inside or outside the vehicle, and information on a location of another vehicle, a speed and a moving direction of the other vehicle sensed from a vehicle-to-vehicle (V2V) communication unit.

In one embodiment, data related to the driving action may include at least one of location information of the vehicle, speed information of the vehicle, and information on a driving path of the vehicle.

In one embodiment, the classifying of the driver's situational driving style may include rescoring the rescored event scores again based on the classified driver's situational driving style.

In one embodiment, the rescoring of the rescored event scores again may include rescoring the event score by reflecting a context score corresponding to at least one context matching the risk event to an event base score according to the determined risk event, changing the event base score or the context score based on the classified driver's situational driving style, and rescoring the rescored event score again based on the changed base score or the context score.

In one embodiment, the calculating of the moving score may include calculating at least one driving score on the trip-by-trip basis having a same classified driver's situational driving style as a single moving score.

In one embodiment, the calculating of the moving score may include collecting at least one driving score on the trip-by-trip basis calculated over a predetermined period of time to calculate a single moving score.

In one embodiment, the method may further include storing the moving score calculated over time, and providing a result of analyzing a history of moving scores stored for a preset period of time according to a risk event or context, or analyzing the driver's driving action based on an increase or decrease in the driving score, as feedback information on the driver's driving score for the preset period of time.

In addition, a data collection device that collects, by a network-based data warehouse system, sensor data items detected from a plurality of sensors provided in a vehicle so as to calculate a driver's driving score may include a communication unit that performs wireless communication with the network-based data warehouse system, a driving context collection unit that collects driving context data items sensed from at least one first device of the vehicle, which is pre-designated to infer a situation related to the driving of the vehicle, a driving situation context collection unit that collects driving situation context data items sensed from at least one second device of the vehicle, which is pre-designated to infer a background situation in which the vehicle is driven, a driving action collection unit that collects driving action data items sensed from at least one third device of the vehicle, which is pre-designated to infer a driving action of a driver driving the vehicle, and a processor that controls the communication unit to transmit sensor data including the driving context data, the driving situation context data and the driving action data to the network-based data warehouse system.

In one embodiment, the at least one first device, the at least one second device and the at least one third device may overlap one another at least partially.

In one embodiment, the processor may be configured to detect sensor data items that satisfy any one of preset risk event occurrence conditions from among the sensor data items, determine a time section in which the sensor data items are detected as an event zone, and determine a risk event corresponding to the event zone based on the sensor data items of the each determined event zone and a risk event occurrence condition that satisfies the sensor data items, extract context data items related to a driving situation of the vehicle from each time section of the sensor data corresponding to each event zone and a time section including predetermined periods of time before and after the each event zone, and determine a context representing a driving situation of the vehicle matching the each event zone based on the extracted context data items, and match each risk event with at least one context based on a risk event and a context determined from each event zone, and transmit the matching result to the network-based data warehouse system, wherein the network-based data warehouse system is configured to rescore an event score of the each risk event based on at least one context matching the each risk event.

In one embodiment, the processor may be configured to classify a background situation in which the vehicle is driven into one of a plurality of preset driving situations based on the driving situation context data items, detect at least one driving characteristic of a driver driving the vehicle based on the driving action data items, and classify the driver's driving style into one of a plurality of preset driving styles based on the detected driving characteristic, and classify a driver's situational driving style corresponding to the sensor data based on the classified driving situation and driving style, and transmit the identification information of the classified driver's situational driving style the network-based data warehouse system, wherein the network-based data warehouse system is configured to calculate a driving score related to the driving of the vehicle based on a base score determined according to the driver's situational driving style corresponding to the received identification information, and the rescored event scores of the respective risk events.

### Advantageous Effects of Invention

The effects of a driving score calculation system and driving score calculation method according to the present disclosure will be described as follows.

According to at least one of embodiments of the present disclosure, the present disclosure detects contexts of driving situations for various risk events occurring during driving, and rescoring event scores for risk events based on the detected contexts to calculate a driving score, thereby having an advantage capable of calculating a driving score that more accurately reflects a driver's actual driving aspect. Accordingly, the present disclosure has an effect of allowing an insurance amount, an insurance premium, or an insurance rating to be determined that accurately satisfies a driver's actual driving aspect.

Furthermore, the present disclosure provides driving situations matching respective risk events that have occurred during driving as contextual information related to the risk events, thereby having an effect of allowing a driver to prove (reason) a cause that can justify the occurrence of a risk event or a cause related to the occurrence of a risk event.

In addition, the present disclosure provides a driver with a driving score that is more suitable for the driver's driving aspect, thereby having an effect of providing feedback that can improve the driver's driving habit based on the driving score.

### BRIEF DESCRIPTION OF DRAWINGS

FIG. 1 is a diagram showing a configuration of a driving score calculation system including a vehicle providing sensor data and a network-based data warehouse system calculating a driving score according to an embodiment of the present disclosure.

FIG. 2 is a block diagram showing a configuration of a sensing data collection device that performs a communication connection with a network-based data warehouse system, and transmits sensor data items collected from a vehicle to the network-based data warehouse system.

FIG. 3 is a block diagram showing a configuration of a network-based data warehouse system that calculates a driving score based on sensor data collected from a vehicle in a driving score calculation system according to an embodiment of the present disclosure.

FIG. 4 is a flowchart showing an operation process of calculating, by a network-based data warehouse system, a driving score based on sensor data collected from a vehicle according to an embodiment of the present disclosure.

FIG. 5 is an exemplary diagram showing an example of determining, by a network-based data warehouse system according to an embodiment of the present disclosure, the occurrence of a risk event from a stream of sensor data in chronological order.

FIG. 6 is an exemplary diagram showing an example of rescoring, by a network-based data warehouse system according to an embodiment of the present disclosure, event scores corresponding to respective risk events based on detected contexts.

FIG. 7 is a flowchart showing an operation process of determining, by a network-based data warehouse system according to an embodiment of the present disclosure, a driving context corresponding to each risk event.

FIG. 8 is an exemplary diagram showing an example of determining, by a network-based data warehouse system according to an embodiment of the present disclosure, a driving context corresponding to each risk event.

FIG. 9 is a flowchart showing an operation process of classifying, by a network-based data warehouse system according to an embodiment of the present disclosure, a driver's situational driving style.

FIG. 10 is a flowchart showing an operation process of providing, by a network-based data warehouse system according to an embodiment of the present disclosure, a service for a result of analyzing moving score history information collected over a predetermined period of time.

FIG. 11 is an exemplary diagram showing an example of providing a result of analyzing moving scores from a network-based data warehouse system according to an embodiment of the present disclosure.

### MODE FOR THE INVENTION

It should be noted that the technical terms used in this specification are only used to describe specific embodiments and are not intended to limit the present disclosure. A singular representation used herein may include a plural representation unless it represents a definitely different meaning from the context. In general, a suffix such as “module” and “unit” may be used to refer to elements or components. Use of such a suffix herein is merely intended to facilitate description of the specification, and the suffix itself is not intended to give any special meaning or function.

In this application, the terms “comprising” and “including” should not be construed to necessarily include all of the elements or steps disclosed herein, and should be construed not to include some of the elements or steps thereof, or should be construed to further include additional elements or steps.

In describing the present disclosure, if a detailed explanation for a related known function or construction is considered to unnecessarily divert the gist of the present disclosure, such explanation has been omitted but would be understood by those skilled in the art.

Furthermore, the accompanying drawings are provided only for a better understanding of the embodiments disclosed herein, and are not intended to limit the technical ideas disclosed herein. Therefore, it should be understood that the accompanying drawings include all modifications, equivalents, and substitutions within the scope and technical ideas of the disclosure. It should also be understood that each of embodiments described below and combinations of those embodiments are all changes, equivalents, or substitutes which can belong to the idea and scope of the present disclosure.

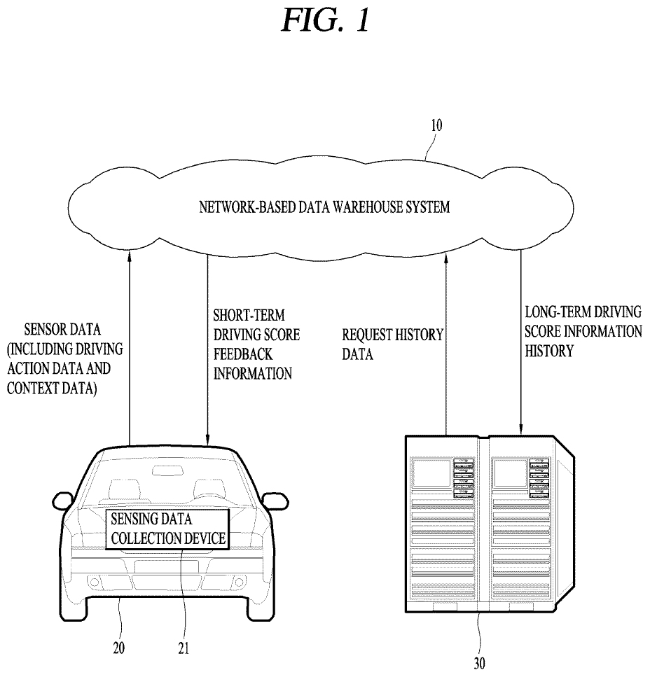

FIG. 1 is a diagram showing a configuration of a driving score calculation system including a vehicle providing sensor data and a network-based data warehouse system calculating a driving score according to an embodiment of the present disclosure.

Referring to FIG. 1, a driving score calculation system according to an embodiment of the present disclosure may include a vehicle 20 that provides sensor data items detected from various sensors and a network-based data warehouse system 10 that calculates a driving score of a driver of the vehicle 20 based on the sensor data items provided from the vehicle 20.

Here, the network-based data warehouse system 10 may be a data management system designed to integrate cloud-based data and activate and support an analysis based on the integrated data. The data warehouse systems may refer to a series of systems that centralize and integrate a large amount of data, provide and record an analysis result based on the data, and store the data.

As an example, the data warehouse system may include elements such as a relational database for storing and managing data, and a data extraction, loading and transformation solution for preparing data for analysis, and statistical, analytical and data mining functions for collected data, and analytical tools for visualizing and providing analyzed data to clients. Meanwhile, the network-based data warehouse system, that is, cloud-based data warehouse system, may also constitute a cloud computing storage platform. However, in the following description, for convenience of explanation, it will be collectively referred to as a network-based data warehouse system.

First, referring to the vehicle 20, the vehicle 20 may be provided with a plurality of sensors that can detect the condition of the vehicle 20 in operation, such as a camera, a speedometer, a navigation system, and a GPS. Furthermore, measurement values measured from the plurality of sensors, that is, sensor data items, may be transmitted to the network-based data warehouse system 10 in chronological order. In this case, the sensor data items provided to the network-based data warehouse system 10 may have a flow of sensor data in chronological order, that is, a form of a stream. Hereinafter, sensor data provided in chronological order will be referred to as a sensor data stream.

Meanwhile, the plurality of sensors may detect various conditions inside and outside the vehicle 20 related to the vehicle 20 in operation. For example, the plurality of sensors may detect a location of the vehicle 20 in operation, a speed of the vehicle 20, an amount of impact applied to the vehicle 20, whether an airbag is discharged, a condition of a driving path on which the vehicle 20 is driving, a driving distance of the vehicle 20, a destination, a driving time of the vehicle 20, an illumination around the vehicle 20, and the like. Alternatively, the plurality of sensors may detect a driver's forward gaze state, whether there is a passenger, and whether the passenger can be identified, whether the passenger is a family member of the driver. Additionally, the plurality of sensors may detect information on a distance from another vehicle around the vehicle 20, a location of the other vehicle, a speed of the other vehicle, a moving direction of the other vehicle, and the like.

To this end, the plurality of sensors may include devices for detecting various conditions inside and outside the vehicle 20. For example, the plurality of sensors may include a vehicle-to-vehicle (V2V) communication module that collects information on other vehicles around the vehicle 20 through V2V communication. In addition, the plurality of sensors may include an in-cabin camera that acquires images inside the vehicle 20, an out-cabin camera (front camera, side camera) that acquires images outside the vehicle 20, a navigation device, a location calculation module such as a GPS, and the like. Additionally, the plurality of sensors may include advanced driver assistance systems (ADAS), and may include sensors such as a speedometer and an impact sensor. Furthermore, the output values of respective devices may be sensor data measured by the plurality of sensors.

Accordingly, the sensor data provided to the network-based data warehouse system 10, which is data related to the driver's driving action of the vehicle 20, may include driving action data that allows to infer the driving action. In addition, the sensor data, which is data related to a situation around the vehicle 20, may include context data that allows to infer the situation around the vehicle 20 while driving the vehicle 20. In addition, the sensor data, which is data related to a driving situation of the driver, such as a passenger riding with the driver, a time at which the vehicle 20 is in operation, a distance to a destination to which the vehicle 20 is in operation, and a driving history to the destination, may include context data that allows to infer a driving situation of the driver.

Hereinafter, context data that allows to infer a situation around the vehicle in motion will be referred to as driving context data, and context data that allows to infer the driver's driving situation will be referred to as driving situation context data.

Here, the driving action data, driving context data, and driving situation context data may each be data sensed from at least one pre-designated sensor. For example, driving action data may include data items sensed from a location calculation module such as a GPS, a speedometer, and a navigation device. Additionally, driving context data may include data items sensed from a V2V communication module, an ADAS device, and an in-cabin camera. In addition, driving situation context data may include data sensed from an in-cabin camera for driver and passenger identification, a navigation device for detecting a distance to a destination and a driving history, a clock, an illumination sensor, and the like.

That is, the sensor data provided from the vehicle 20 to the network-based data warehouse system 10 may include various data items for inferring context related to the driving of the vehicle 20, such as driving action data, vehicle context data, and driving situation context data, and may also include data items sensed from a plurality of sensors pre-designated for each context inference. In this case, the sensors designated for each context inference may overlap at least partially, and in this case, the sensing data sensed by the sensors whose designations overlap may be used for two or more context inferences (e.g., in-cabin camera sensing data: may be used for both driving context inference and driving situation context inference).

Meanwhile, the network-based data warehouse system 10 may determine whether a pre-specified risk event has occurred from the sensing data when the sensing data is provided from the vehicle 20. Furthermore, when it is determined that a risk event has occurred, context information items corresponding to a time section (context zone) corresponding to the occurred risk event may be detected from the context data from among the sensing data. Furthermore, based on the detected context information items, it may be possible to infer a situation that occurred while the vehicle 20 was driving during the time when the risk event occurred (determine whether a context occurred). Furthermore, when the inferred situation (context) is a situation related to the occurred risk event, an event score corresponding to the risk event may be rescored by reflecting a positive or negative weight according to the inferred situation (context) to a preset event score corresponding to the risk event. Furthermore, the rescoring process may be performed for each risk event determined through the sensing data.

Furthermore, the network-based data warehouse system 10 may classify a driving style of the driver driving the vehicle 20 based on a driving action data included in the sensing data. Furthermore, based on driving situation context data included in the sensing data, a driving situation in which the driver drives the vehicle 20 may be classified. Furthermore, based on the classified driving style and driving situation, the driver's situational driving style may be classified.

Once the driver's situational driving style is classified, the network-based data warehouse system 10 may reflect the rescored event scores for respective risk events detected from the sensor data to a driving score corresponding to the classified driver's situational driving style. Furthermore, the driver's driving score may be calculated by reflecting the rescored event scores to the driving score.

Here, the sensor data may be data collected from a start of operation of the vehicle 20 until an end of operation of the vehicle 20. Here, the start and end of operation of the vehicle 20 may be determined depending on whether the vehicle 20 is turned on or off.

Meanwhile, the driving of the vehicle 20 from the start of operation of the vehicle 20 until the end of operation may be referred to as a trip. Then, the sensor data may be provided to the network-based data warehouse system 10 on the trip-by-trip basis, and the network-based data warehouse system 10 may determine whether the risk events have occurred on a trip-by-trip basis, and perform event score rescoring for the respective risk events that have occurred. Furthermore, the rescored event scores may be reflected to a driving score classified according to the driver's situational driving style. Here, the driving score to which the rescored event scores are reflected may be the driving score on the trip-by-trip basis.

Therefore, the network-based data warehouse system 10 may calculate a driving score that reflects the rescored event scores based on the driver's situational driving style and the inferred situations (contexts) related to respective risk events that have occurred, on a trip-by-trip basis. Furthermore, based on at least one driving score on a trip-by-trip basis having a same driver's situational driving style, a moving score may be calculated, and the calculated moving score may be stored in chronological order. That is, moving score history information for a predetermined period of time may be generated.

Meanwhile, the generated moving score history information may be utilized in various ways. As an example, the moving score history information may be used to provide feedback to the driver based on an increase or decrease in driving scores over a short period of time. Additionally, based on moving score history information analyzed on the basis of a specific risk event or a specific context, information on risk events that occur frequently in the specific context may be provided. In this case, information on a specific context that leads to a specific risk event may be provided to the driver, thereby providing feedback that can correct the driver's bad driving habit.

Alternatively, the moving score history information may be used to analyze statistical data, and the like in an external server 30 of an insurance company, or the like, as shown in FIG. 1. As an example, the moving history information for a long period of time, such as on a yearly basis, may be used to determine the driver's insurance amount, insurance premium, or insurance rating. Alternatively, it may be used to analyze various accident statistics, such as risk events that frequently occur in a specific context.

Meanwhile, in order to calculate the driving score, the vehicle 20 of the driving score calculation system according to an embodiment of the present disclosure may collect data items sensed from a plurality of sensors provided in the vehicle 20. To this end, the vehicle 20 may be provided with a sensing data collection device 21 that is connected to an interface unit 220 of the vehicle 20 to collect the sensing data items from the plurality of sensors provided in the vehicle 20, and the sensing data collection device 21 may perform a role of collecting the sensing data and transmitting the collected sensing data to the network-based data warehouse system 10.

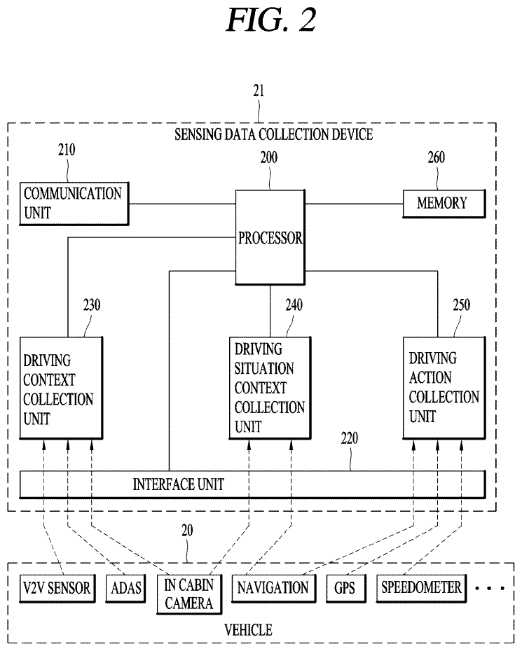

As described above, FIG. 2 is a block diagram showing a configuration of a sensing data collection device 21 that performs communication connection with the network-based data warehouse system 10 and transmits sensor data items collected from the vehicle 20 to the network-based data warehouse system 10.

Referring to FIG. 2, the sensing data collection device 21 may include a processor 200, a communication unit 210 connected to the processor 200, an interface unit 220, and at least one collection unit 230, 240, 250 that collects sensor data items from the vehicle 20 connected through the interface unit 220.

The elements shown in FIG. 2 are not essentially required to implement the sensing data collection device 21, and thus the sensing data collection device 21 described herein may include more or fewer elements than those listed above.

First, the communication unit 210 may perform wireless communication between the sensing data collection device 21 and a preset server. To this end, the communication unit 210 may include at least one of a transmitting antenna, a receiving antenna, and a radio frequency (RF) circuit and an RF element capable of implementing various communication protocols.

Here, the communication unit 210 may be a communication unit provided in the vehicle 20 rather than the sensing data collection device 21. In this case, the sensing data collection device 21 may be connected to the communication unit of the vehicle 20 through the interface unit 220, and the processor 200 may also control the communication unit of the vehicle 20 by way of the interface unit 220. However, for convenience of explanation, the following description assumes that the sensing data collection device 21 is provided with the communication unit 210.

Meanwhile, the preset server, which is at least part of the network-based data warehouse system 10 connected through wireless communication, may be a server that infers driving situations for respective risk events that have occurred during the driving of the vehicle 20 according to an embodiment of the present disclosure, and rescores event scores corresponding to the respective risk events according to the inferred driving situations to calculate a driving score that reflects the rescored event scores.

Meanwhile, turning to the interface unit 220, the interface unit 220 may be connected to an interface unit (not shown, hereinafter referred to as a vehicle interface unit) of the vehicle 20, and may receive detection results detected from a plurality of sensors provided in the vehicle 20 through the vehicle interface unit. Here, the vehicle interface unit may perform a role of a passage between various types of external devices connected to the vehicle 20 or respective components of the vehicle 20. For example, the vehicle interface unit may be provided with various ports connected to the interface unit 220, and may be connected to the interface unit 220 through the ports. Furthermore, data may be exchanged through the interface unit 220.

As described above, the interface unit 220 may be connected to the respective components of the vehicle 20 through the vehicle interface unit. As an example, the interface unit 220 may be connected to at least one camera of the vehicle 20, for example, an in-cabin camera that senses an image inside a cabin of the vehicle 20, or an out-cabin camera that senses an image outside the vehicle 20, for example, an image of the front or side of the vehicle, and may receive images sensed by respective cameras.

In addition, the interface unit 220 may be connected to a navigation device, that is, a path guidance device of the vehicle 10 through the vehicle interface unit. Furthermore, navigation information provided from the connected navigation device may be transmitted to the processor 200. In this case, the navigation device may provide a driving history to a currently set destination, a distance or an expected arrival time to the destination, path information to the destination, and the like through the interface unit 220.

In addition, the interface unit 220 may be connected to devices such as a speedometer of a vehicle 20, a V2V communication device (hereinafter referred to as a V2V sensor), an ADAS, or a positioning module such as a GPS. Furthermore, it may receive various information upon request from the connected devices. As an example, the interface unit 220 may receive a location of another vehicle around the vehicle 20, a speed of the other vehicle, and a moving direction of the other vehicle from the V2V sensor. In addition, information such as detection results acquired through the ADAS by way of the interface unit 220, for example, a distance from a front vehicle detected using radar, distances from other vehicles on the side and rear, a collision risk detection result, a lane following detection result, and the like may be received. Furthermore, information such as a current location of the vehicle 20 from the positioning module, and a current speed and acceleration of the vehicle 20 from the speedometer, and the like may be received.

Meanwhile, according to an embodiment of the present disclosure, the sensing data collection device 21 provided in the vehicle 20 may request sensor data items for inferring a driver's driving action or driving situation (context) from the vehicle 20 through the interface unit 220 from the network-based data warehouse system 10 according to an embodiment of the present disclosure, and receive detection results detected from the respective components of the vehicle 20 in response to the request. In this case, the data for inferring respective contexts may be data items sensed from different sensors of the vehicle 20. Accordingly, sensors that sense data items for respective context inferences may be pre-designated. Accordingly, the sensing data collection device 21 may include a plurality of collection units 230, 240, 250 that request data items used for each context inference from the interface unit 220 and collect data items through the interface unit 220 in response to the request.

As an example, when a risk event such as rapid deceleration, rapid acceleration, speeding, or impact occurs, in order to infer a driving situation of the vehicle 20 in which the risk event has occurred, data items for determining a situation around the vehicle 20, for example, data items on locations, speeds, and distances of other vehicles around the vehicle 20 and a situation inside the vehicle 20, may be required. Accordingly, the sensing data collection device 21 may include a driving context collection unit 230 that collects data such as locations, speeds, distances of other vehicles around the vehicle 20, and a situation inside the vehicle 20.

In this case, the driving context collection unit 230 may request sensing data from sensors such as the V2V sensor and ADAS of the vehicle 20 through the interface unit 220. Additionally, data sensed from the in-cabin camera may be requested through the in-cabin camera. Accordingly, sensor data items related to locations, speeds, distances of other vehicles around the vehicle 20 and a situation inside the vehicle 20 may be collected. Then, the processor 200 may transmit the sensor data items collected from the driving context collection unit 230 as sensor data related to the driving context to the network-based data warehouse system 10 through the communication unit 210.

In addition, in order to infer a driving situation in which the driver operates the vehicle 20, data items such as information on a destination, a driving history to the destination, a driving path, a driving time, and the like, as well as a driver identification result, whether there is a passenger on board, and if the passenger on board can be identified, an identification result of the passenger may be required. Accordingly, the sensing data collection device 21 may include the driving situation context collection unit 240 that collects navigation information of the vehicle 20 and data sensed from the driver and passengers on board the vehicle 20.

In this case, the driving situation context collection unit 240 may request data such as a destination, a driving history to the destination, a driving path, and a driving time from the navigation device of the vehicle 20 through the interface unit 220. Additionally, data sensed from the in-cabin camera may be requested to sense the driver and passengers. Accordingly, information items on a driving path of the vehicle, such as a destination, a driving history to the destination (whether or not there has been a driving experience to the destination), a driving path or time, and the like may be collected. In addition, information items on a result of identifying the driver and passengers may be collected. Then, the processor 200 may transmit the sensor data items collected from the driving situation collection unit 240 as sensor data related to the driving situation context to the network-based data warehouse system 10 through the communication unit 210.

Meanwhile, the sensing data collection device 21 may include the driving action collection unit 250 that collects data items for inferring the driver's driving action. As an example, the driving action collection unit 250 may collect data such as a location of the vehicle 20 detected through the positioning module and a vehicle speed (speed, acceleration, etc.) detected from the speedometer of the vehicle 20. Additionally, information on a driving path of the vehicle 20 may be received from the navigation device. In this case, a driving action of the driver who controls the operation of the vehicle 20 may be inferred based on a driving path of the vehicle 20, a location of the vehicle 20, and a change in speed in the driving path according to the location of the vehicle 20.

Furthermore, the driving action collection unit 250 may request context data for inferring the driver's driving action, that is, driving action data items, through the interface unit 220 from the sensors of the vehicle 20 (e.g., navigation device, positioning module (GPS), speedometer) and collect the driving action data items in response to the request.

Meanwhile, in such cases, the driving context collection unit 230 and the driving situation context collection unit 240 may request the sensing data of the in-cabin camera as driving context data or driving situation context data from the interface unit 220. In addition, the driving situation context collection unit 240 and the driving action collection unit 250 may each request data from the navigation device of the vehicle 20 to collect the driving situation context data and the driving action data for inferring the driver's driving action.

As such, in a case where a plurality of collection units request data sensed from the same sensor, the processor 200 may control, when the data sensed from the same sensor is received according to a request of any one of the plurality of collection units, another collection unit such that the other collection unit does not request data sensed from the same sensor. Accordingly, it may be possible to prevent data sensed by the same sensor from being collected in a plurality of different collection units.

Meanwhile, the memory 260 may store data supporting various functions of the sensing data collection device 21. For example, the memory 260 may store a plurality of application programs (or applications) that can be executed by the processor 200, data items for the operation of the sensing data collection device 21, and commands.

Additionally, the memory 260 may store information on sensors from which respective collection units 230, 240, 250 receive sensing data from the vehicle 20. Accordingly, the respective collection units 230, 240, 250 may connect to the respective sensors of the vehicle 20 specified in the memory 260 through the interface unit 220 and receive data items sensed from the connected sensors.

Meanwhile, the processor 200 controls each connected component and typically controls an overall operation of the sensing data collection device 21. The processor 200 may be connected to the vehicle 20 by controlling the interface unit 220, and may perform a communication connection with the network-based data warehouse system 10 by controlling the communication unit 210. Furthermore, depending on the turning on and off of the vehicle 20, the start and end of the operation of the vehicle 20 may be detected, and the sensor data items collected during the operation of the vehicle 20 from the start of the detected operation to the end of the operation of the vehicle 20 may be transmitted to the network-based data warehouse system 10 as sensor data for the operation of the vehicle, that is, a trip.

To this end, the processor 200 may control the interface unit 220 while the vehicle 20 is in operation to allow the respective components of the vehicle 20 to be respectively connected to the plurality of collection units 230, 240, 250, and control the plurality of collection units 230, 240, 250 to collect data items, that is, sensor data items, from the respective sensors of the vehicle 20 connected through the interface unit 220. Furthermore, the sensor data items collected from the plurality of collection units 230, 240, 250 may be integrated, and the integrated sensor data items may be transmitted to the network-based data warehouse system 10 through the communication unit 210. Then, the network-based data warehouse system 10 may calculate a driving score during the operation of the vehicle 20 on a trip-by-trip basis based on the received sensor data.

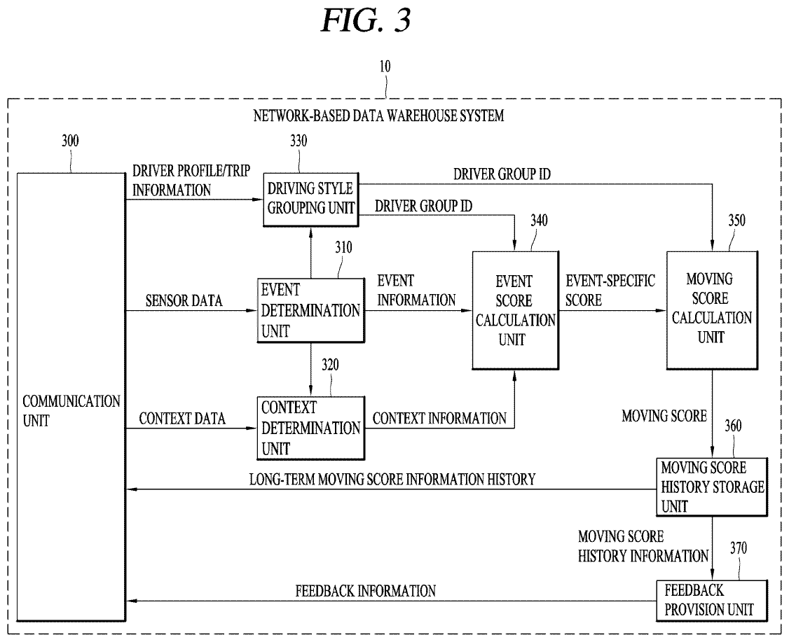

Meanwhile, FIG. 3 is a block diagram showing a configuration of the network-based data warehouse system 10 that calculates a driving score based on sensor data collected from the vehicle 20 in a driving score calculation system according to an embodiment of the present disclosure.

Referring to FIG. 3, the network-based data warehouse system 10 that calculates a driving score according to an embodiment of the present disclosure may include a communication unit 300 that receives sensor data from the vehicle 20, an event determination unit 310 that determines whether a risk event has occurred based on the received sensor data, a context determination unit 320 that determines a driving situation (context) for each of the risk events that have occurred, a driving style grouping unit 330 that classifies a driver's situational driving style based on the sensor data, an event score calculation unit 340 that rescores event scores for respective risk events that have occurred by reflecting a result of the determination of the context determination unit 320 or a result of the determination of the context determination unit 320 and the classified driver's situational driving style, a moving score calculation unit 350 that calculates a moving score by collecting at least one driving score on a trip-by-trip basis to which the rescored event scores are reflected, and a moving score history storage unit 360 that stores the calculated moving score in chronological order. In addition, the network-based data warehouse system 10 may further include a feedback provision unit 370 that can provide feedback to the driver based on a moving score for the predetermined period of time, that is, moving score history information.

The elements shown in FIG. 3 are not essentially required to implement the network-based data warehouse system 10, and thus, the network-based data warehouse system 10 described herein may have more or fewer elements than those listed above.

First, referring to FIG. 3, the communication unit 300 may perform wireless communication with the vehicle 20. Through this, the communication unit 300 may receive sensor data items transmitted from the vehicle 20. In this case, the sensor data may include detection values respectively detected by a plurality of sensors provided in the vehicle 20, including data collected from the driving context collection unit 230 (driving context data), data collected from the driving situation context collection unit (driving situation context data), and data collected from the driving action collection unit (driving action data). Additionally, the sensor data may be listed in chronological order. The sensor data items listed in chronological order as described above will be referred to below as a sensor data stream.

In addition, the communication unit 300 may perform wireless communication with another preset server, for example, an insurance company's server. Through this, the communication unit 300 may provide a driving score calculation result, for example, the moving score history information or the like, as a response to a request from the other server.

Furthermore, the event determination unit 310 may detect a time section including data items corresponding to a preset risk event from a stream of the sensor data received through the communication unit 300. Here, the risk events, which are events that are subtraction factors in calculating driving scores, such as rapid deceleration, rapid acceleration, speeding, and impact, may be designated in advance. As an example, an insurance company or the like may pre-specify risk events for measuring drivers' insurance premiums, insurance payments, or insurance ratings, and may pre-specify conditions corresponding to the respective specified risk events. As an example, in the case of rapid deceleration or rapid acceleration, it may be a vehicle speed that has been decelerated or accelerated above a predetermined level over a predetermined period of time, and in this case, the predetermined period of time and speed conditions for determining rapid deceleration and rapid acceleration may be specified.

The event determination unit 310 may analyze the sensing data stream to detect a portion of the time section including sensor data items that satisfy conditions corresponding to the respective pre-specified risk events. Furthermore, when a time section that satisfies the specified risk event conditions is detected, the detected time section may be set as a time section in which a risk event has occurred, that is, an event zone. Furthermore, based on the sensor data items of the set event zone, a risk event that satisfies the event zone may be identified (e.g., when the speed decreases by a specified level or more within a specified period of time-detecting a time section of a sensor data stream corresponding to the risk event ‘rapid deceleration’ as an event zone, and identifying the risk event ‘rapid deceleration’ corresponding to the detected event zone).

Meanwhile, the event determination unit 310 may detect a plurality of different event zones from the sensor data stream, and identify risk events corresponding to respective event zones. Accordingly, the sensor data stream, that is, time sections during which situations responding to risk events have occurred while the vehicle 20 is in operation (trip), and the risk events that have occurred during those time sections may be identified. In this case, the identified risk event may be identified by unique information of the risk event, for example, risk event ID information.

The event determination unit 310 may be a module to which machine learning technology is applied. In this case, the event determination unit 310 may detect an event zone from the sensor data stream and identify a risk event in the detected event zone using the machine learning technology.

When event zones are identified from the event determination unit 310, the context determination unit 320 may identify sensor data items for each of the identified event zones from the sensor data stream provided from the communication unit 300. Furthermore, based on the sensor data items corresponding to each event zone, the driving situation (context) of the vehicle 20 during the time section corresponding to each event zone may be inferred.

In this case, the inference of the driving situation (context) may be provided to determine whether a preset driving situation has occurred based on driving context data. To this end, the context determination unit 320 may, similarly to the event determination unit 310, include information on conditions for various different context determinations that are set in advance. As an example, when a detection result detected by an ADAS from driving context data indicates that another vehicle approaches the vehicle 20 from one side of the vehicle 20 and a moving speed of the other vehicle is above a predetermined speed, the context determination unit 320 may determine that the driving context data indicates that a cut-in (cut in, sudden rush out) has occurred due to the other vehicle.

That is, the context determination unit 320 may include conditions corresponding to a plurality of different driving situations, that is, context determination conditions, and when context data that satisfies the context determination condition is detected, it may be determined as the occurrence of the context.

Meanwhile, here, the context determination unit 320 may limit the type of context to be determined depending on the type of risk event corresponding to the event zone. In this case, the types and number of contexts, that is, preset driving situations in which occurrence or non-occurrence of different risk events can be determined, may vary. In such cases, contexts that are less related to risk events may not be determined to have occurred, so the load and computational amount of the context determination unit 320 may be reduced.

The context determination unit 320 may be a module to which machine learning technology is applied. In this case, the context determination unit 320 may determine whether a preset context that satisfies a context determination condition has occurred in each event zone detected from the sensor data stream using the machine learning technology.

Furthermore, once the context is determined, the identification information of the determined context may be matched to a risk event corresponding to the event zone. Therefore, unique information of at least one context corresponding to each risk event ID, for example, a context ID, may be matched. In this case, a matching table may be generated in which at least one context ID is matched to each risk event ID.

Meanwhile, the driving style grouping unit 330 may detect data items related to a driving situation, such as a driver's identification result and a destination of the vehicle 20 in operation, that is, driving situation context data items, from the sensor data stream. Furthermore, from the detected driving situation context data, information items on a surrounding situation related to the operation of the vehicle, such as whether there is a passenger, whether there is a driving experience to the destination (a driving history to the destination), a driving distance and driving time to the destination, a time at which the vehicle is operated, and an ambient illuminance, may be detected. Furthermore, based on the detected surrounding situation, a driving situation in which the driver drove the vehicle may be classified into one of a plurality of preset driving situations.

In addition, the driving style grouping unit 330 may detect data items related to a driver's driving action, that is, driving action data items, from the sensor data stream. Furthermore, based on the detected driving action data items, the driving characteristics of the driver who drove the vehicle 20 may be detected. Furthermore, based on at least one of the detected driving characteristics, the driving style of the driver may be classified into one of a plurality of preset driving styles.

Furthermore, the driving style grouping unit 330 may classify the driver's situational driving style regarding the operation of the vehicle 20 based on the classified driving situation and driving style. Here, the driving style grouping unit 330 may classify a driver's aspect into any one of a plurality of driver's preset situational driving styles corresponding to respective combinations of the plurality of preset driving situations and the plurality of preset driving styles.

For example, if there are 6 driving situations that can be determined based on the driving situation context data, and 6 driver's driving styles that can be determined based on the driving action data, the driver's situational driving style may be determined as one of a total of 36 (6×6) different combinations of driving situations and driving styles.

In this case, a plurality of driver's situational driving styles corresponding to different combinations of the driving situations and driving styles may respectively have unique identification information. Accordingly, the driving style grouping unit 330 may determine that any one of the plurality of driver's situational driving styles corresponds to currently received sensor data based on the driving situation context data items and driving action data items included in the sensor data. In this case, the determined situational driver driving style may be represented by an ID of the classified group, that is, a group ID.

Meanwhile, when detecting data items related to a driver's driving action, that is, driving action data items, from the driver's sensor data stream, the driving style grouping unit 330 may detect the driving action data items in the remaining time sections excluding the time section corresponding to the event zone determined by the event determination unit 310. This is because the driving action data items of the time section corresponding to the event zone may have already been determined to be the action due to the occurrence of a risk event.

As such, when driving action data items are detected from the sensor data stream of the remaining time sections excluding the time section corresponding to the event zone, the driving action data items may be driving action data items unrelated to the risk event. That is, it may be data items representing the driver's general driving action. Accordingly, the driving style grouping unit 330 may detect at least one driving characteristic for determining the driver's driving style based on driving action data detected from the sensor data stream of the remaining time sections excluding the time section corresponding to the event zone. Furthermore, based on the detected driving characteristics, the driver's driving style may be determined.

Meanwhile, when at least one risk event detected from a sensor data stream is detected (a risk event ID) by the event determination unit 310, and a driving situation (context) corresponding to the detected each risk event is determined (a context ID) by the context determination unit 320, information items on at least one context corresponding to each risk event (at least one context ID corresponding to each risk event ID) may be input to the event score calculation unit 340. Then, the event score calculation unit 340 may calculate an event score for each risk event according to the detected context.

As an example, each risk event may have a pre-assigned penalty score. In this case, when there is no inferred driving situation (context) for the occurred risk event, that is, when the risk event has occurred without any reason, then the event score calculation unit 340 may calculate the score assigned to the risk event as the event score. Therefore, for example, in a case where the event score corresponding to the risk event ‘rapid deceleration’ is −3 points, when a ‘cut-in’ caused by another vehicle is determined as a context within a time section of the event zone corresponding to the risk event, the event score calculation unit 340 may rescore the event score by applying a weight corresponding to the determined context.

In this case, when the weight of the context corresponding to the ‘cut-in’ is 5 points, the event score calculation unit 340 may calculate the event score corresponding to the risk event ‘rapid deceleration’ as 2 (−3+5=2) points. That is, even when a risk event occurs, the event score corresponding to the risk event may be different if there is a sufficient reason, that is, a context, corresponding to the occurrence of the risk event. That is, the network-based data warehouse system 10 according to an embodiment of the present disclosure may apply different event scores corresponding to the risk event by reflecting a driving situation corresponding to the risk event.

The event score calculation unit 340 may dynamically change and apply an event score to at least one context determined for each of the determined risk events. That is, event scores for the respective determined risk events may be rescored according to at least one determined context corresponding to each risk event.

In addition, when rescoring the event score corresponding to each risk event based on at least one context determined for each risk event, the event score calculation unit 340 may rescore the rescored event score again by reflecting a situational driver driving style determined by the driving style grouping unit 330, that is, a group ID.

As an example, the situational driver driving style may emphasize safer driving when there is a passenger rather than when there is no passenger. Accordingly, the event score calculation unit 340 may further assign a negative or positive weight to an event score corresponding to each risk event, depending on whether there is a passenger, or further assign a negative or positive weight to a weight corresponding to a specific context. That is, depending on the driver's group ID determined by the driving style grouping unit 330, an additional weight may be further assigned to an event score corresponding to each risk event, or an additional weight may be further assigned to a weight corresponding to each context. In such cases, the event score calculation unit 340 may rescore event scores corresponding to respective risk events by reflecting not only a driving situation (context) that has occurred for each risk event, but also the driver's driving situation and driving style (the driver's situational driving style).

Meanwhile, the moving score calculation unit 350 may receive event scores for respective risk events rescored by the event score calculation unit 340. Furthermore, a group ID according to the driver's situational driving style determined by the driving style grouping unit 330 may be received. Furthermore, by reflecting the event scores for respective risk events received from the event score calculation unit 340 to the base driving score determined according to the group ID, a driving score corresponding to currently received sensor data may be calculated.

Here, the moving score calculation unit 350 may set different base driving scores according to the group ID. In this case, base driving scores, which are different depending on the group ID, may be higher the closer the driver's situational driving style is to a safe driving standard, and lower the further the driver's driving style is from the safe driving standard.

As an example, a base driving score corresponding to the group ID of the situational driver driving style in a case where the driver is driving at a speed exceeding a recommended driving speed, although not speeding, may be set lower than that in a case where the driver is driving at a recommended driving speed under other conditions being the same. That is, the more the driver's situational driving style is toward safe driving, the higher the base driving score may be set.

Meanwhile, the sensor data may be data collected from the vehicle 20 from a start of operation of the vehicle 20 (ignition on) until an end of operation (ignition off). Hereinafter, an operation of the vehicle from when the vehicle is turned on until when the vehicle is turned off is referred to as a trip. In such cases, the moving score calculation unit 350 may calculate the driving score while the vehicle is being operated corresponding to a single trip.

However, in the case of a trip, it may be long or short based on a period of time or distance the vehicle is operated. That is, the variation may be very large. As such, a driving score on a trip-by-trip basis is fragmentary, and thus may not be suitable as an indicator of how safely the driver drove. Accordingly, the moving score calculation unit 350 may collect at least one driving score calculated on the trip-by-trip basis to calculate a moving score from at least one driving score on the trip-by-trip basis. As an example, the moving score calculation unit 350 may calculate an average of a plurality of driving scores calculated on a trip-by-trip basis and calculate the calculated average score as a driving score for the plurality of trips, that is, a moving score.

Here, the moving score calculation unit 350 may collect a plurality of driving scores having a same group ID, that is, a same situational driver driving style, for a plurality of driving scores calculated on a trip-by-trip basis. Furthermore, the plurality of collected driving scores on a trip-by-trip basis may be calculated as a moving score. In such cases, a driving score that corresponds to a specific situational driver driving style, that is, a moving score, may be calculated.

In addition, the moving score calculation unit 350 may calculate the moving score on a predetermined period basis. For example, if the period of time is one month, then the moving score calculation unit 350 may calculate a moving score for the one month by collecting driving scores on the trip-by-trip basis calculated during the month. Here, the moving scores may of course be collected based on the situational driver driving styles.

Furthermore, the moving score calculation unit 350 may store the calculated moving scores in the moving score history storage unit 360 in chronological order. Then, the moving scores may be stored in chronological order to constitute a history of moving scores. Hereinafter, the moving scores stored for a predetermined period of time are referred to as moving score history information. As such, moving scores stored in chronological order may correspond to driving scores over a predetermined period of time. Accordingly, the driving score history information may be used to provide a service using a driving score, such as determining an insurance premium or insurance rating, or providing feedback on the driver's driving habit.

The network-based data warehouse system 10 may provide the moving score history information over a predetermined period of time upon request from a preset external server 30, such as an insurance company server. As an example, an insurance company may request moving score history information for a relatively long period of time, such as several months or years, from the moving score history storage unit 360, and receive moving score history information for the several months or on a yearly basis in response to the request. Then, the external server 30 may determine whether the driver drives safely based on a result of analyzing the moving score history information and determine an insurance amount, insurance premium, or the driver's insurance rating based on a result of the determination. To this end, an insurance company or the like may assign its own weight to each risk event included in the moving score history information, or a driving context matching the risk event, or a driver's situational driving style.

Alternatively, the network-based data warehouse system 10 may further include a feedback provision unit 370 that provides feedback information to a driver based on the moving score history information. As an example, the feedback provision unit 370 may request moving score history information for a relatively short period of time on a several days or several weeks basis, from the moving score history storage unit 360, and in response to the request, may receive moving score history information for the several days or several weeks basis.

Then, the feedback provision unit 370 may analyze the provided moving score history information and provide a result of the analysis to the driver. As an example, the feedback provision unit 370 may sort risk events in order of the number of occurrences, and detect at least one driving context that has occurred in common from among risk events that have occurred more than a preset number of times. That is, the feedback provision unit 370 may provide information on risk events that have mainly occurred in specific driving context situations to the driver.

Alternatively, the feedback provision unit 370 may provide a result of analyzing a history of driving contexts matched in a specific risk event, or provide the driver with evidence, that is, a reason why the driving score is added or subtracted by the risk event and driving context.

Additionally, based on the group ID of each moving score included in the moving score history information, information on the driver's driving styles that have mainly occurred in specific driving situations may be provided. Furthermore, based on the analyzed result, advice may be given to avoid a decrease in driving score, for example, measures to prevent the occurrence of driving contexts that occur in specific risky events, for example, suggesting to change the driver's driving habit (e.g. rapid deceleration-driving context: distraction, look ahead to avoid a reduction of points).

The result of analyzing short-term moving score history information may be usefully used in determining a driving aspect of a specific driver, such as whether or not he or she drives safely, in the case of using shared vehicles through car sharing services or renting vehicles through car rental services, and the like. It may also be used to analyze more detailed driving scores and optimize insurance information.

Meanwhile, in the foregoing description, respective components of the vehicle 20 and the network-based data warehouse system 10 in a driving score calculation system according to the embodiment of the present disclosure and operations of the respective components have been described in detail.

In the following description, with reference to a plurality of flowcharts, an operation process of calculating, by the network-based data warehouse system 10 according to an embodiment of the present disclosure, driving scores, that is, moving score history information, calculated over a predetermined period of time based on sensor data (sensor data stream) provided from the vehicle 20, will be described in more detail.

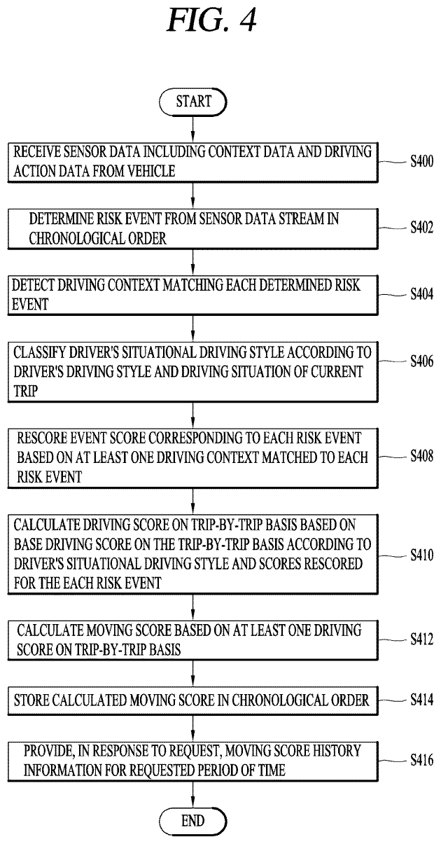

FIG. 4 is a flowchart showing an operation process of calculating, by the network-based data warehouse system of the driving score calculation system according to an embodiment of the present disclosure, a driving score based on sensor data collected from a vehicle.

Referring to FIG. 4, the network-based data warehouse system 10 may receive sensor data including driving context data, driving situation context data, and driving action data from the vehicle 20 connected to communication (S400).

In this case, the sensor data may be data items collected from the sensing data collection device 21 including a driving context collection unit 230 that collects data sensed from at least one device of the vehicle 20 that is pre-designated to infer a driving situation of the vehicle 20, a driving situation context collection unit 240 that collects data sensed from at least one device of the vehicle 20 that is pre-designated to infer a driver's driving situation, and a driving action collection unit 250 that collects data sensed from at least one device of the vehicle 20 that is pre-designated to infer a driver's driving action.

Furthermore, the sensing data collection device 21 or the vehicle 20 may transmit data collected from at least one device provided in the vehicle 20 in chronological order in which the data is generated. Accordingly, the sensor data may be received in the form of a stream in chronological order. As such, the sensor data received in the form of a stream is referred to as a sensor data stream.

Then, the network-based data warehouse system 10 may determine whether a risk event has occurred from the sensor data stream (S402).

Here, the risk events, which are events that are subtraction factors in calculating driving scores, such as rapid deceleration, rapid acceleration, speeding, and impact, may be designated in advance. Additionally, event occurrence conditions corresponding to each specified risk event may be pre-specified. As an example, in the case of rapid deceleration or rapid acceleration, it may be a vehicle speed that has been decelerated or accelerated above a predetermined level over a predetermined period of time, and in this case, the predetermined period of time and speed conditions for determining rapid deceleration and rapid acceleration may be specified.

Accordingly, the network-based data warehouse system 10 may detect an event zone, that is, a portion of a time section including sensor data items that satisfy conditions corresponding to the respective pre-specified risk events from the sensing data stream. Furthermore, a risk event corresponding to the detected event zone may be identified.

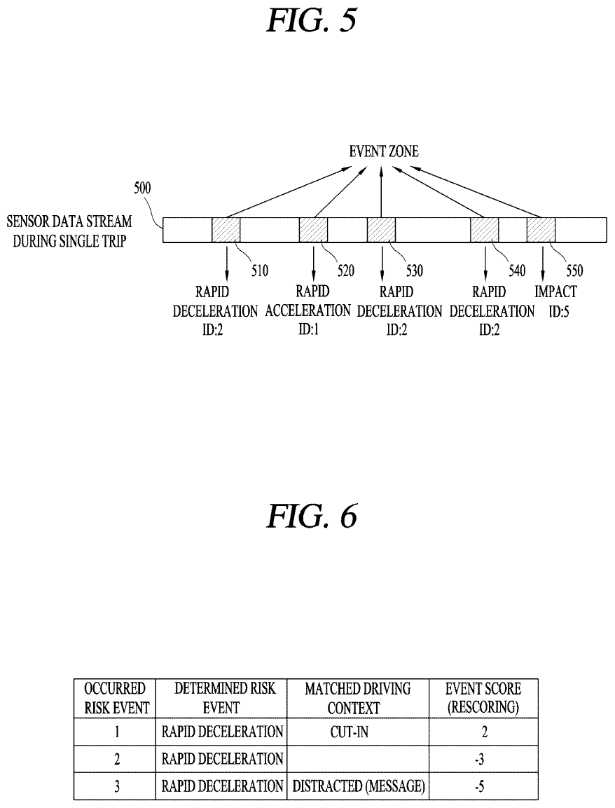

FIG. 5 is an exemplary diagram showing an example of detecting, by the network-based data warehouse system 10 according to an embodiment of the present disclosure, an event zone from the sensor data stream and determining a risk event from the detected event zone.

Referring to FIG. 5, the network-based data warehouse system 10 may first detect sensor data items that satisfy pre-specified event occurrence conditions. Furthermore, event zones may be set based on the detected sections. For convenience of explanation, the following description assumes that rapid deceleration, rapid acceleration, and impact are specified as risk events, and that event occurrence conditions corresponding to respective risk events are specified. However, the present disclosure is not of course limited thereto.

As an example, the network-based data warehouse system 10 may detect sensor data items indicating that the speed of the vehicle 20 has decreased or increased above a predetermined level over a preset period of time from a sensor data stream 500. Additionally, the network-based data warehouse system 10 may detect sensor data items indicating an impact amount or vibration exceeding a preset level from the sensor data stream 500.

Here, the speed of the vehicle 20 that has decreased or increased above a predetermined level over the predetermined period of time may be an event occurrence condition for determining the occurrence of a risk event corresponding to rapid deceleration or rapid acceleration. In addition, an impart amount or vibration exceeding the preset level may be an event occurrence condition for determining the occurrence of a risk event corresponding to the impact.

As a result of the detection, first to fifth event zones 510 to 550 may be detected from the sensor data stream 500. Then, the network-based data warehouse system 10 may identify a risk event corresponding to each event zone from the sensor data items of the respective detected event zones 510 to 550. In this case, as shown in FIG. 5, it may be determined that a rapid deceleration risk event has occurred for the first, third, and fourth event zones 510, 530, 540, a rapid acceleration risk event has occurred for the second event zone 520, and an impact risk event has occurred for the fifth event zone 550. Then, the event determination unit 310 may match unique information of the identified risk event, such as the risk event ID, to each event zone 510 to 550.

Meanwhile, when a risk event is determined from the sensor data stream in the step S402, the network-based data warehouse system 10 may determine whether there is a driving situation, that is, a driving context, matching each of the determined risk events (S404).

In the step S404, the network-based data warehouse system 10 may first extract sensor data items (hereinafter referred to as driving context data) corresponding to the driving context from a section of sensor data corresponding to a time section corresponding to each event zone and a time section including predetermined periods of time before and after the event zone. Furthermore, the network-based data warehouse system 10 may determine whether driving context data detected from a time section including an event zone and predetermined periods of time before and after the event zone satisfies a preset driving context determination condition. Furthermore, depending on whether the determined driving context determination condition is satisfied or not, it may be determined whether a preset driving context has occurred in each event zone. Furthermore, when a driving context is determined from a time section including an event zone, the determined driving context may be matched to a risk event identified in the event zone.

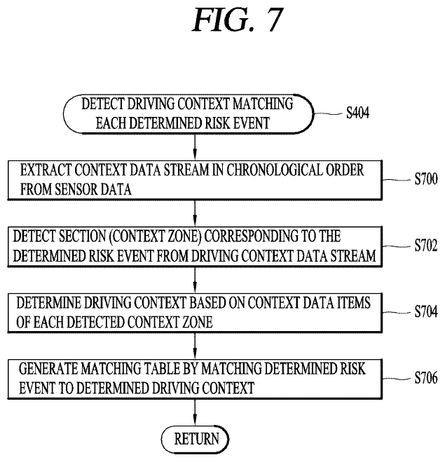

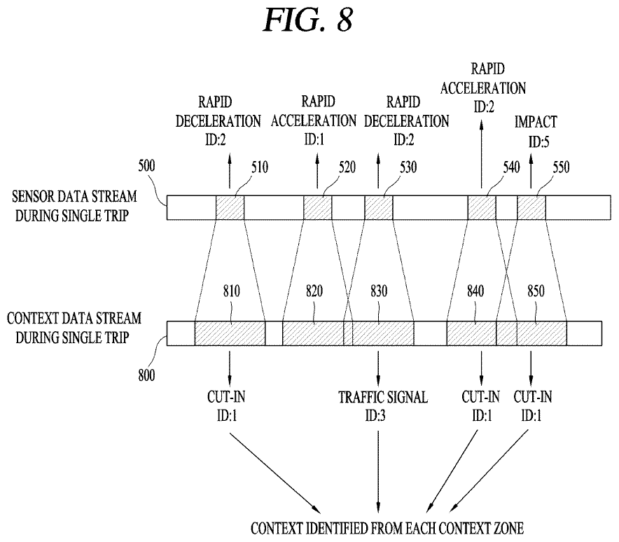

Hereinafter, an operation process in the step S404 of determining driving contexts from respective event zones where risk events are determined and matching the determined driving contexts to the risk events identified from the event zones will be described in more detail with reference to FIGS. 7 and 8.

Meanwhile, the network-based data warehouse system 10 may classify a driver's driving situation and driving style from a sensor data stream. Furthermore, based on the classified driving style and driving situation, the driver's situational driving style may be classified into a specific group (S406).

To this end, the network-based data warehouse system 10 may detect data items related to a driving situation, such as a driver's identification result and a destination of the vehicle 20 in operation, from the sensor data stream, that is, context data related to the driving situation (hereinafter referred to as driving situation context data items). Furthermore, based on the detected driving situation context data items, the driving situation in which the driver drove the vehicle 20 may be classified into one of a plurality of preset driving situations.

In addition, the network-based data warehouse system 10 may detect data items related to a driver's driving action, that is, driving action data items, from the sensor data stream. Furthermore, based on the detected driving action data items, the driving characteristics of the driver who drove the vehicle 20 may be detected. Furthermore, based on at least one of the detected driving characteristics, the driving style of the driver may be classified into one of a plurality of preset driving styles.

Furthermore, the network-based data warehouse system 10 may classify a driving aspect of a driver corresponding to the sensor data stream into one of a plurality of preset situational driver driving styles based on combinations of the classified driving situations and driving styles. In this case, the network-based data warehouse system 10 may determine any one identification information (group ID) corresponding to the sensor data stream from among the plurality of preset situational driving styles as a situational driver driving style corresponding to the sensor data stream.

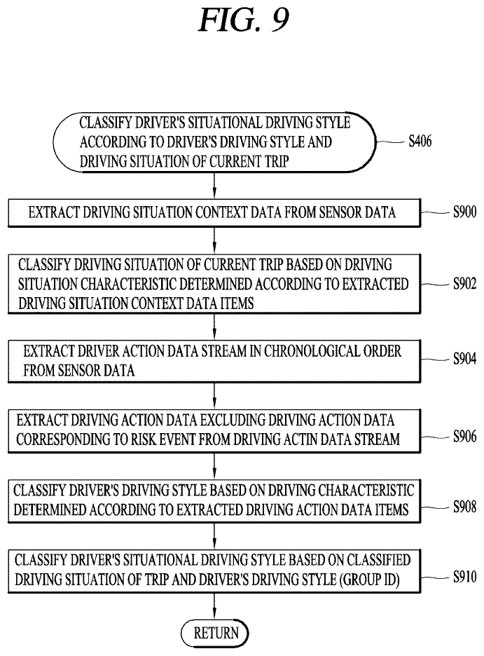

Hereinafter, an operation process in the step S406 of grouping a driver's situational driving style into a specific group will be described in more detail with reference to FIG. 9.

Meanwhile, when a driving context matching an event zone in which a risk event is determined in the step S404 is determined, the network-based data warehouse system 10 may rescore event scores corresponding to the respective risk events by reflecting the determined driving context (S408).

As an example, each risk event may have a pre-assigned penalty score. In this case, if a driving context matching the occurred risk event is not determined, then the network-based data warehouse system 10 may determine that a risk event has occurred without a specific reason. Therefore, a score assigned to that risk event may be calculated as it is as an event score that is reflected to the driving score.

On the contrary, if at least one driving context matching the occurred risk event is determined, then the network-based data warehouse system 10 may rescore an event score corresponding to the risk event by reflecting a weight corresponding to the at least one determined driving context to a score assigned to the risk event.

FIG. 6 is an exemplary diagram showing an example of rescoring, by the network-based data warehouse system 10 according to an embodiment of the present disclosure, event scores corresponding to respective risk events based on driving contexts matched to the risk events.

Referring to FIG. 6, FIG. 6 shows an example in which three rapid decelerations are identified as risk events. Furthermore, it is assumed an example in which a case where a ‘cut-in’ caused by another vehicle is matched as a driving context for risk event No. 1 ‘rapid deceleration’, a case where a context is not determined for risk event No. 2 ‘rapid deceleration’, and a case where a driving context is determined to be ‘distracted’ for risk event No. 3 ‘rapid deceleration’ because a driver did not pay attention to the front due to checking messages.

In this case, assuming that a pre-specified event score for the risk event ‘rapid deceleration’ is-3 points, the pre-specified event score of −3 points for ‘rapid deceleration’ may be calculated as it is for risk event No. 2 for which the driving context is not determined. However, for risk event No. 1 in which rapid deceleration is carried out due to a ‘cut-in’ caused by another vehicle, a weight based on the matched driving context ‘cut-in’ may be reflected to the event score. In this case, the risk event No. 1 ‘rapid deceleration’ is to avoid a collision with another vehicle that has caused the ‘cut-in’, and a weight of 5 points according to the ‘cut-in’ may be reflected to the event score. Therefore, for the risk event No. 1 ‘rapid deceleration’, an event score of 2 points (5−3) may be calculated.

However, turning to the case of risk event No. 3 ‘rapid deceleration’, the driver's negligence in looking ahead (′distracted (checking messages)′) may be determined as the driving context. Therefore, in the case of the risk event No. 3 ‘rapid deceleration’, the weight of −2 points corresponding to the driving context ‘distracted (checking message)’ may be reflected to the event score. Therefore, for the risk event No. 3 ‘rapid deceleration’, an event score of −5 points (−2−3) may be calculated.

Meanwhile, an event score rescoring process in the step S408 may be performed for respective risk events detected from the sensor data stream.

Here, the step S408 may further include rescoring the rescored event scores again by reflecting the situational driver driving style calculated in the step S406.

As an example, the network-based data warehouse system 10 may further assign a negative or positive weight to an event score corresponding to each risk event based on a driver's situational driving style determined in the step S406, that is, a group ID. Alternatively, the network-based data warehouse system 10 may further assign a negative or positive weight to a weight corresponding to a specific context. Furthermore, for each risk event, in addition to a weight according to a driving context matching each risk event, at least one weight according to the driver's driving situation and driving style (the driver's situational driving style) may be further reflected to rescore event scores corresponding to respective risk events.

Furthermore, the network-based data warehouse system 10 may set different base driving scores according to a driver's situational driving style classified in the step S406, that is, a group ID. In this case, the base driving score may have a higher value as the driver's situational driving style approaches safe driving. Furthermore, event scores for respective risk events rescored in the step S406 may be reflected to a base driving score set according to the classified driver's situational driving style to calculate a driving score corresponding to the sensor data stream (S410). In this case, the sensor data stream may be collected while operating the vehicle 20 from a start of operation of the vehicle 20 until an end of operation. In this case, if the operation of the vehicle from a start of operation of the vehicle 20 until an end of operation is referred to as a trip, the network-based data warehouse system 10 may calculate a driving score on a trip-by-trip basis in the step S410.

In the step S410, when a driving score on a trip-by-trip basis is calculated, the network-based data warehouse system 10 may calculate a moving score based on at least one driving score on the trip-by-trip basis (S412). Here, the network-based data warehouse system 10 may collect driving scores on a trip-by-trip basis calculated over a predetermined period of time to calculate moving scores corresponding to the driving scores over the predetermined period of time.

Alternatively, at least one driving score on a trip-by-trip basis having a same driver's situational driving style may be collected to calculate a moving score, which is a driving score corresponding to a driver's specific situational driving style. Here, the collection may refer to calculating a statistical result for the at least one driving score on a trip-by-trip basis, such as an average, or may refer to summing the at least one driving score on a trip-by-trip basis.

Furthermore, once the moving score is calculated, the network-based data warehouse system 10 may store the calculated moving score (S414). In this case, the network-based data warehouse system 10 may sequentially store the moving scores in chronological order. Then, the moving scores stored in chronological order may be stored as history information of moving scores, that is, moving score history information.

When moving score history information is stored in the step S414, the network-based data warehouse system 10 may provide, in response to a request, moving score history information for the requested period of time (S416).

The network-based data warehouse system 10 may provide moving score history information for a relatively long period of time, such as several months or years, depending on a preset external server 30, for example, an insurance company server. Then, the external server 30 may assign its own weight to each risk event included in the moving score history information, a driving context matching the risk event, a driver's situational driving style, or the like and determine whether the driver drives safely based on a result of the assigned weight. Furthermore, a result of the determination may be reflected in determining an insurance amount, insurance premium, or a driver's insurance rating. Alternatively, the long-term moving score history information may be used as data for various statistical analyses, such as statistical analysis of accident types.

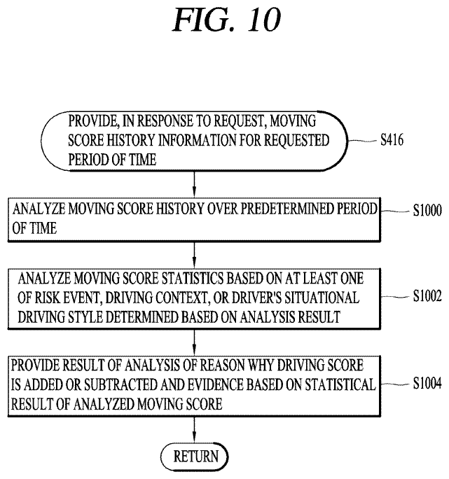

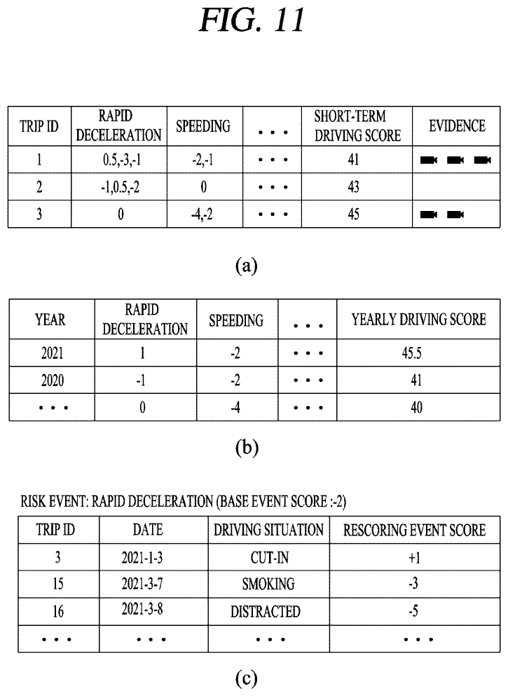

Alternatively, the network-based data warehouse system 10 may further provide feedback information to the driver based on the moving score history information. As an example, the network-based data warehouse system 10 may analyze moving score history information for a relatively short period of time on a several days or several weeks basis, and provide the analyzed result to the driver. Furthermore, based on the analyzed result, a result of analysis based on either a risk event or driving context, or a result of analyzing the driver's situational driving style may be fed back to the driver. As such, the feedback information items provided by the network-based data warehouse system 10 based on a result of analyzing moving score history information will be described in more detail with reference to FIGS. 10 and 11 below.

FIG. 7 is a flowchart showing an operation process of determining, by the network-based data warehouse system 10 according to an embodiment of the present disclosure, a driving context corresponding to each risk event. Furthermore, FIG. 8 is an exemplary diagram showing an example of determining, by a cloud server according to an embodiment of the present disclosure, a context corresponding to each risk event.

Referring to FIG. 7, the network-based data warehouse system 10 according to an embodiment of the present disclosure may first extract, when the detection of a driving context matching each risk event identified from a sensor data stream begins in the step S404, data items corresponding to driving contexts in chronological order from the sensor data stream (hereinafter, driving context data items) (S700). Here, the driving context data items may be data sensed from at least one device of the vehicle 20 that is pre-designated to infer a driving situation of the vehicle 20. Here, if the sensor data items are collected by the sensing data collection device 21 provided in the vehicle 20, then the driving context data items may be data items collected by the driving context collection unit 230. Additionally, the driving context data items may have the form of a stream sorted in chronological order. Hereinafter, data in which the driving context data items are listed in the form of a stream in chronological order is referred to as a driving context stream.

In the step S700, when a driving context data stream is extracted, the network-based data warehouse system 10 may detect, from the driving context data stream, a time section corresponding to each event zone detected from the sensor data stream and a time section including predetermined periods of time before and after the event zone. Furthermore, each detected time section may be detected as a context zone matching each event zone. Furthermore, driving context data items included in each detected context zone may be detected.

FIG. 8 is an example diagram showing an example in which context zones matching respective event zones of a sensor data stream are detected from a context data stream.

Referring to FIG. 8, when first to fifth event zones 510 to 550 are detected from the sensor data stream 500, the network-based data warehouse system 10 may detect first to fifth context zones 810 to 850 that match the first to fifth event zones 510 to 550, respectively, from a context data stream 800. In this case, the first event zone 510 may be matched to the first context zone 810, the second event zone 520 to the second context zone 820, the third event zone 530 to the third context zone 830, the fourth event zone 540 to the fourth context zone 840, and the fifth event zone 550 to the fifth context zone 850, respectively.

Here, each context zone may further include a time section corresponding to the matching event zone, as well as time sections corresponding to predetermined periods of time before and after the matching event zone, in order to comprehensively determine situations before and after a risk event that has occurred in the event zone. Accordingly, driving context data items detected over a wider time section than that corresponding to any one event zone may be detected as driving context data corresponding to the any one event zone.

In the step S702, when context zones matching respective event zones, that is, including time sections corresponding to the respective event zones, are detected and driving context data items included in the respective detected context zones are detected, the network-based data warehouse system 10 may determine whether a preset driving context has occurred from the driving context data items of the respective detected context zones (S704).

In order to determine the driving context, the network-based data warehouse system 10 may store information on a context determination condition corresponding to at least one different driving context. Furthermore, the driving context data items detected from the respective context zones may be compared with context determination conditions corresponding to at least one different driving context. Furthermore, when the driving contexts included in the context zone satisfy a determination condition corresponding to a specific driving context, it may be determined that the specific driving context has occurred in that context zone.

Referring to FIG. 8, which shows an example of the driving context data stream 800, an example is shown in which a ‘cut-in’ is determined to have occurred as a driving context in the first context zone 810 and the fourth to fifth context zones 840, 850. Additionally, the third context zone 830 shows an example in which ‘traffic signal’ is determined as a driving context. Furthermore, the context data items of the second context zone 820 shows an example of a case where it does not satisfy any of the determination conditions of the preset driving contexts. In this case, the network-based data warehouse system 10 may determine that no driving context has occurred in the second context zone 820.

Then, the network-based data warehouse system 10 may match driving contexts matching risk events determined from respective event zones based on a driving context determined from a context zone that matches each event zone. In this case, as shown in FIG. 8, a risk event determined in each event zone may be matched to a driving context determined from a context zone matching each event zone.

Therefore, a risk event ‘rapid deceleration’ determined in the first event zone 510 may be matched to a driving context ‘cut-in’ determined in the first context zone 810. Furthermore, a risk event ‘rapid deceleration’ determined in the third event zone 530 may be matched to a driving context ‘traffic signal’ determined in the third context zone 830. Furthermore, risk events ‘rapid deceleration’ and ‘impact’ determined in the fourth event zone 540 and the fifth event zone 550 may be respectively matched to a driving context ‘cut-in’ determined in the fourth context zone 840 and a driving context ‘cut-in’ determined in the fifth context zone 850. However, in the case of a risk event ‘rapid acceleration’ determined in the second event zone 520, a driving context may not be matched because the driving context is not determined in the second context zone 820 matching the second event zone 520.

As such, when risk events determined in respective event zones and driving contexts determined in context zones matching the respective event zones are matched, the network-based data warehouse system 10 may generate a matching table representing the matched risk events and driving contexts (S706). In this case, the matching table may include identification information items (IDs) of respective driving contexts that match risk event identification information items (IDs) corresponding to respective determined risk events.

Meanwhile, as shown in FIG. 8, context zones may overlap one another at least partially. In this case, driving context data items included in context zones of overlapping areas may be commonly used to determine driving contexts matching a plurality of risk events. That is, one driving situation (driving context) may be matched to a plurality of risk events.

In addition, driving context data detected in one context zone may satisfy a determination condition for a plurality of different driving contexts. In this case, the network-based data warehouse system 10 may determine that a plurality of different driving contexts have occurred in one context zone. Therefore, a single risk event may match a plurality of different driving contexts.

In this case, when rescoring an event score corresponding to each risk event, the network-based data warehouse system 10 may reflect all weights for respective plurality of driving contexts matching the risk event to the event score of each risk event. For example, in a case where ‘cut-in’ and ‘distracted’ are determined as driving contexts for the risk event ‘rapid deceleration’, the network-based data warehouse system 10 may reflect all weights corresponding to the plurality of driving contexts to an event score corresponding to one risk event.

In this case, if an event score corresponding to the risk event ‘rapid deceleration’ is −3 points, a weight corresponding to the driving context ‘cut-in’ is +3 points, and a weight corresponding to the driving context ‘distracted’ is −2 points, then the network-based data warehouse system 10 may calculate the event score as −2 points (−3+3−2=−2) for the risk event ‘rapid deceleration’. That is, when it is determined that a specific risk event has occurred, the network-based data warehouse system 10 according to an embodiment of the present disclosure may determine an event score corresponding to the specific risk event by comprehensively considering all driving situations at the time when the specific risk event occurred.

Meanwhile, the network-based data warehouse system 10 may also limit the type of driving context to be determined based on the risk event identified in the event zone. In such cases, the types of driving contexts that can be determined in each event zone may differ depending on the risk event determined in that event zone.

Meanwhile, according to the foregoing description, it has been described that the driving score calculation system according to an embodiment of the present disclosure can, in addition to the driving situation (driving context) that occurs while driving the vehicle 20, determine a background situation in which the driver's driving is carried out, such as the presence or absence of a passenger, the destination, and the time at which the vehicle is operated, and a driving style of the driver driving the vehicle 20, and classify the driver's driving style according to the situation, that is, the driver's situational driving style, based on the determined driving situation and driving style.

FIG. 9 is a flowchart showing an operation process of classifying, by the network-based data warehouse system 10 according to an embodiment of the present disclosure, the driver's situational driving style as described above.

When step S406 of FIG. 4, which classifies a driver's situational driving style, begins, the network-based data warehouse system 10 may extract driving situation context data items related to a driving situation of the vehicle 20 from the sensor data of the vehicle 20 received from the communication unit 300 (S900).

Here, the driving situation context data items, which are information items on background situations related to the operation of the vehicle, such as whether there is a passenger, whether there is a driving experience to the destination (a driving history to the destination), a driving distance and driving time to the destination, a time at which the vehicle is operated, an ambient illumination, a driver or passenger identification result (whether it is the driver's own vehicle, whether the passenger is the driver's family member), may be data sensed from at least one device of the vehicle 20 that is pre-designated to infer the driving situation. Here, if the sensor data items are collected by the sensing data collection device 21 provided in the vehicle 20, then the driving situation context data items may be data items collected by the driving situation context collection unit 240.

Furthermore, the network-based data warehouse system 10 may classify a driving situation in which the driver drove the vehicle 20 into one of a plurality of preset driving situations based on the detected driving situation context data items (S902).

Furthermore, a, the network-based data warehouse system 10 may detect data items related to a driver's driving action, that is, driving action data items, from the sensor data stream (S904).

Here, the driving action data items, which are information items that can infer a driving action of a driver who operates the vehicle 20 based on a result of operating the vehicle 20, such as a location of the vehicle 20, a change in the speed of the vehicle 20, may be data sensed from at least one device of the vehicle 20 that is pre-designated to infer the driving action. Here, if the sensor data items are collected by the sensing data collection device 21 provided in the vehicle 20, then the driving action data items may be data items collected by the driving action collection unit 250. Additionally, the driving action data items may have the form of a stream sorted in chronological order. Hereinafter, data in which the driving action data items are listed in the form of a stream in chronological order is referred to as a driving action stream.

When the driving action data stream is extracted in the step S904, the network-based data warehouse system 10 may detect the driving characteristics of the driver who drove the vehicle 20 based on the extracted driving action data items.

For example, the driving action data may include information such as locations of the vehicle 20 measured through the positioning module, a speed of the vehicle 20 measured in chronological order, and a driving path. Then, the network-based data warehouse system 10 may calculate an average driving speed of the operated vehicle 20 and compare the calculated average driving speed with a preset driving speed to determine whether the driver drove the vehicle 20 at high speed, constant speed, or low speed. Furthermore, based on the determined result, a speed characteristic at which the driver operates the vehicle 20 may be determined. Here, the preset driving speed may be a preset speed or a recommended speed set for a path along which the vehicle 20 is operated.

Additionally, the network-based data warehouse system 10 may calculate a speed deviation based on a preset time unit for a driving speed of the vehicle 20. Here, the speed deviation may be acceleration per the preset time unit. Furthermore, based on a difference between the calculated speed deviations, it may be possible to determine how stably the driver drives the vehicle (driving stability characteristics). That is, the larger the difference between the speed deviations (or accelerations), the more roughly the driver may have driven the vehicle 20, and the smaller the difference between the speed deviations (or accelerations), the more smoothly the driver may have driven the vehicle 20.

In addition, the network-based data warehouse system 10 may detect a driving speed in each area on a driving path acquired through navigation information. That is, the network-based data warehouse system 10 may calculate an operation speed or speed deviation of a vehicle for each driving area, and may determine the driving style of a driver for a specific driving area based on the calculated operation speed or speed deviation (area-specific driving characteristics).

Meanwhile, in the foregoing description, only speed characteristics, driving stability characteristics, and area-specific driving characteristics have been mentioned, but the network-based data warehouse system 10 may further determine at least one other driving characteristic in addition to the foregoing driving characteristics based on the driving action data items. Furthermore, based on the determined driving characteristics, the driving style of the driver may be classified into one of a plurality of preset driving styles.

Meanwhile, the driving action data items may further include data items related to the determined risk event. For example, in the case of driving action data items detected in a time section corresponding to the foregoing event zone, they may be driving action data items related to a risk event corresponding to the event zone.

Therefore, the driving action data items related to the risk event, which are data items corresponding to specific situations (e.g., rapid deceleration, rapid acceleration, speeding, impact), may be data items that have already been determined as a risk event. In addition, the data items corresponding to the specific situations, which are data items detected under the specific situations (risk events), may not be suitable as data for determining the driver's driving style in daily conditions other than the specific situations.

Accordingly, the network-based data warehouse system 10 may detect driving action data items excluding driving action data items included in time sections corresponding to respective event zones from the driving action data stream (S906). Furthermore, based on the driving action data items of the remaining driving action data stream from which the driving action data items of the time sections corresponding to the event zones have been removed, the driver's driving characteristics, such as speed characteristics, driving stability characteristics, and area-specific driving characteristics, may be calculated. Furthermore, based on the calculated results, the driver's driving styles in the daily conditions may be determined (S908).

Meanwhile, in the step S906, an example of excluding driving action data items included in time sections corresponding to respective event zones from the driving action data stream has been described, but driving action data items excluding driving action data items of time sections corresponding to respective context zones detected in the step S702 of FIG. 7 may of course be detected. In such cases, not only the driving action data detected at the time of the risk event, but also the driving action data items detected before and after the risk event occurs, that is, the driving action data items that were affected to a small extent by the risk event, may be further removed. Therefore, the driver's driving styles in the daily conditions may be determined more accurately.

When the driver's driving style is classified in the step S908, the network-based data warehouse system 10 may classify the driver's situational driving style regarding the operation of the vehicle 20 based on the classified driving situation and driving style (S910). Here, the network-based data warehouse system 10 may classify a driver's situational driving style corresponding to a currently received sensor data stream into one of the plurality of situational driver driving styles, based on a combination of a driving situation classified into one of the plurality of preset driving situations and a driving style classified into one of the plurality of preset driving styles. In this case, the one classified situational driver driving style may be represented by one of the plurality of situational driver driving styles, that is, a group ID. Accordingly, the situational driver driving style (group ID) corresponding to the sensor data stream, that is, the operation of the vehicle on a trip-by-trip basis, may be classified.

Meanwhile, according to the foregoing description, it has been mentioned that the network-based data warehouse system 10 of the driving score calculation system according to an embodiment of the present disclosure can provide various services based on moving score history information collected over a predetermined period of time from moving scores calculated by at least one driving score on a trip-by-trip basis.

FIG. 10 is a flowchart showing an operation process of providing, by the network-based data warehouse system 10, a service for a result of analyzing moving score history information collected over a predetermined period of time as described above.

First, referring to FIG. 10, the network-based data warehouse system 10 may analyze moving scores stored in chronological order for a preset period of time, that is, moving score history information for the preset period of time (S1000). In this case, the moving score history information may be classified into short-term or long-term depending on a length of the preset period of time. As an example, if the preset period is several days or several weeks, then it may be classified as short-term moving score history information, and if the preset period is several months or several years, then it may be classified as long-term moving score history information.

When the moving score history information is analyzed in the step S1000, the network-based data warehouse system 10 may perform statistical analysis on the moving score based on at least one of the risk event, driving context, or situational driver driving style determined based on the analysis result (S1002). Furthermore, based on the statistical result of the analyzed moving score, a result of analysis of a reason why the driving score is added or subtracted, and evidence for the subtraction of the points may be provided (S1004).

FIG. 11 is an exemplary diagram showing an example of providing a result of analyzing moving scores from the network-based data warehouse system 10 according to an embodiment of the present disclosure.

First, (a) of FIG. 11 shows an example of providing an analysis result in which moving scores for a short period of time are analyzed for respective risk events. As shown in (a) of FIG. 11, the cloud server may display risk events that occurred while operating the vehicle on a trip-by-trip basis, for each trip unit, and may display rescored event scores for respective risk events.

Therefore, as shown in (a) of FIG. 11, even for one risk event (e.g., rapid deceleration), various different event scores 0.5, −3, −1 may be displayed. This is because, even if it is the same risk event, different weights are reflected depending on a driving situation inferred at the time each risk event occurred, that is, a driving context.

Meanwhile, as shown in (a) of FIG. 11, the network-based data warehouse system 10 may present, when there is a driving context determined for a specific risk event, driving context data related to the driving context as evidence. In this case, if the driving context data is image information sensed from an in-cabin camera or an out-cabin camera, the sensed image information may be provided as a basis for the rescoring. Therefore, a driver who receives the analysis result such as (a) of FIG. 11 may present the sensed image information to an insurance company, or the like, as evidence for event score rescoring.

In addition, the network-based data warehouse system 10 may provide a long-term moving history score analysis result, such as on a yearly basis, as shown in (b) of FIG. 11.

In addition, the network-based data warehouse system 10 may sort risk events in order of the number of occurrences, and detect at least one driving context that has occurred in common from among risk events that have occurred more than a preset number of times. That is, the feedback provision unit 370 may provide information on risk events that have mainly occurred in specific driving context situations to the driver.

Alternatively, the network-based data warehouse system 10 may provide a result of analyzing a history of driving contexts matched in a specific risk event, as shown in (c) of FIG. 11, or provide the driver with evidence, that is, a reason why the driving score is added or subtracted by the risk event and driving context. Furthermore, based on the group ID of each moving score included in the moving score history information, information on the driver's driving styles that have mainly occurred in specific driving situations may be provided. Furthermore, based on the analyzed result, advice may be given to avoid a decrease in driving score, for example, measures to prevent the occurrence of driving contexts that occur in specific risky events, for example, suggesting to change the driver's driving habit (e.g. rapid deceleration-driving context: distraction, look ahead to avoid a reduction of points).

Meanwhile, the short-term moving score history information may be used to analyze a driver's driving score in an environment such as a rental car or car sharing. Alternatively, it may be used to provide evidence (context-specific evidence) for detailed analysis of a driver's driving score during the short-term period, optimization of insurance information when using the rental car or car sharing, insurance claim, and the like.

Alternatively, the long-term moving score history information may be used by an insurance company or the like to determine a subscriber's insurance rating and insurance amount, and may be used as a basis for upgrading the subscriber's insurance amount or insurance rating. In addition, it may be used to create various accident statistics, such as a driving context and a driving situation context for each risk event.

Meanwhile, in the foregoing description, it has been described a configuration in which the vehicle 20 provides data items sensed by a plurality of sensors as sensor data to the network-based data warehouse system 10 in the form of a stream. However, in such cases, there is a problem in that the amount of data transmitted to the network-based data warehouse system 10 may become too large. As an example, data sensed from a camera may be a video, and in this case, a relatively large volume of data must be transmitted to the network-based data warehouse system 10. Therefore, there is a problem in that network traffic may increase excessively, which may cause a bottleneck.

In order to solve such a traffic problem, the driving score calculation system according to an embodiment of the present disclosure may perform, when the vehicle 20 ends an operation on the trip-by-trip basis, at least one of determining the occurrence of a risk event, inferring a driving situation corresponding to the occurred risk event (determining a driving context), and classifying a driver's situational driving style according to driving situation context data, based on sensor data items collected from a plurality of sensors during the operation on the trip-by-trip basis that has ended. In this case, a controller of the vehicle 20, or a processor of the sensing data collection device 21 that collects data sensed by each sensor unit of the vehicle 20 according to an embodiment of the present disclosure, may perform at least one of determining the risk event, determining the driving context, and classifying a driver's situational driving style according to driving action data and driving situation context.

To this end, machine learning technology may be applied to the controller of the vehicle 20 or the processor of the sensing data collection device 21, and an algorithm according to the machine learning technology and information items on weights and matrices to be provided at each hidden stage may be stored in the memory of the vehicle 20 or the memory of the sensing data collection device 21.

As such, when at least one of determining the risk event, determining the driving context, and classifying a driver's situational driving style according to driving action data and driving situation context is carried out in the vehicle 20 while operating the vehicle 20, the vehicle 20 may provide at least one of the identification information (risk event ID) of the occurred risk event and the identification information (context ID) of the inferred driving situation (driving context) related to the occurred risk event to the network-based data warehouse system 10. Alternatively, if the determination of the risk event and the determination of the driving context are both carried out in the vehicle 20, the vehicle 20 may provide a matching table containing information (context ID) of at least one driving context matched to the risk event (risk event ID) to the network-based data warehouse system 10.

Then, the network-based data warehouse system 10 may identify risk events that occurred during the operation of the vehicle 20 on the trip-by-trip basis that has ended, and identify driving contexts matched to respective risk events based on the matching table. Furthermore, for each risk event that has occurred, an event score corresponding to the risk event may be rescored by reflecting weights corresponding to at least one driving context matching the risk event to a preset event score corresponding to the risk event.

In addition, when the driver's situational driving style is classified in the vehicle 20, the vehicle 20 may provide a group ID according to the classified result to the network-based data warehouse system 10. Then, the network-based data warehouse system 10 may determine a driving score on a trip-by-trip basis in which the operation has ended based on the group ID provided from the vehicle 20.

Meanwhile, as described above, if the vehicle 20 performs at least one of determining the occurrence of a risk event, inferring a driving situation corresponding to the occurred risk event (determining a driving context), and classifying a driver's situational driving style according to driving situation context data, then at least a portion of the sensor data may not be transmitted to the network-based data warehouse system 10. As an example, if the vehicle 20 performs all of determining the occurrence of a risk event, inferring a driving situation corresponding to the occurred risk event (determining a driving context), and classifying a driver's situational driving style according to driving situation context data, then the sensor data may not be transmitted to the network-based data warehouse system 10.

The disclosure may be implemented as computer-readable codes in a program-recorded medium. The computer readable medium includes all kinds of recording devices in which data readable by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device and the like, and may also be implemented in the form of a carrier wave (e.g., transmission over the Internet). Therefore, the detailed description should not be limitedly construed in all of the aspects, and should be understood to be illustrative. The scope of the present disclosure should be determined by reasonable interpretation of the appended claims, and all changes within the equivalent scope of the present disclosure are embraced by the appended claims.

1. A method of calculating, by a network-based data warehouse system, a driver's driving score based on sensor data items detected from a vehicle, the method comprising:
receiving sensor data items detected from a plurality of sensors provided in the vehicle:
determining at least one preset risk event based on the received sensor data items:
determining at least one context matching each of the at least one determined risk event based on context data items included in the received sensor data items:
rescoring an event score corresponding to each of the determined risk events based on the at least one determined context; and
calculating a driving score related to the driving of the vehicle based on the rescored event scores of the respective risk events,
wherein the calculating of the driving score comprises:
detecting data related to a driver's driving action from the sensor data items;
detecting the driver's driving characteristic from the detected driving action data;
classifying the driver's situational driving style based on the detected driving characteristic and the driver's driving situation, and rescoring the rescored event scores again based on the classified driver's situational driving style;
reflecting the rescored event scores corresponding to the respective determined risk events to a base driving score on a trip-by-trip basis calculated according to the classified driver's situational driving style to calculate a moving score on the trip-by-trip basis.

2. (canceled)

3. The method of claim 1, wherein the determining of the at least one risk event comprises:
detecting sensor data items that satisfy any one of preset risk event occurrence conditions from among the sensor data items, determining a time section in which the sensor data items are detected as an event zone, and determining a risk event corresponding to the event zone based on the sensor data items of the each determined event zone and a risk event occurrence condition that satisfies the sensor data items.

4. The method of claim 3, wherein the determining of the at least one context comprises:
extracting context data items related to a driving situation of the vehicle from respective time sections of the sensor data corresponding to each event zone and a time section including predetermined periods of time before and after the each event zone; and
determining a context representing a driving situation of the vehicle matching the each event zone based on the extracted context data items.

5. The method of claim 1, wherein the classifying of the driver's situational driving style comprises:
detecting the driver's driving characteristic from the remaining driving action data items excluding the driving action data corresponding to the determined risk event from among the sensor data items.

6. The method of claim 1, wherein the driver's driving characteristic comprises:
at least one of a speed characteristic according to an average speed of the vehicle, an area-specific driving characteristic according to an area-specific speed of a path on which the vehicle drives, and a driving stability characteristic according to a speed deviation.

7. The method of claim 1, wherein the driver's driving situation comprises:
at least one of a driving history to a destination on a driving path, a driving time, whether there is a passenger, whether the driver is driving his or her own vehicle, and a distance to the destination.

8. The method of claim 1, wherein the context data is data collected from at least one sensor that detects a situation inside and outside the vehicle, the context data comprising at least one of detection values of advanced driver assistance systems (ADAS), an image of a camera sensing an image inside or outside the vehicle, and information on a location of another vehicle, a speed and a moving direction of the other vehicle sensed from a vehicle-to-vehicle (V2V) communication unit.

9. The method of claim 1, wherein data related to the driving action comprises:
at least one of location information of the vehicle, speed information of the vehicle, and information on a driving path of the vehicle.

10. (canceled)

11. The method of claim 10, wherein the rescoring of the rescored event scores again comprises:
rescoring the event score by reflecting a context score corresponding to at least one context matching the risk event to an event base score according to the determined risk event;
changing the event base score or the context score based on the classified driver's situational driving style; and
rescoring the rescored event score again based on the changed base score or the context score.

12. The method of claim 2, wherein the calculating of the moving score comprises:
calculating at least one driving score on the trip-by-trip basis having a same classified driver's situational driving style as a single moving score.

13. The method of claim 2, wherein the calculating of the moving score comprises:
collecting at least one driving score on the trip-by-trip basis calculated over a predetermined period of time to calculate a single moving score.

14. The method of claim 2, further comprising:
storing the moving score calculated over time; and
providing a result of analyzing a history of moving scores stored for a preset period of time according to a risk event or context, or analyzing the driver's driving action based on an increase or decrease in the driving score, as feedback information on the driver's driving score for the preset period of time.

15. A data collection device that collects, by a network-based data warehouse system, sensor data items detected from a plurality of sensors provided in a vehicle so as to calculate a driver's driving score, the device comprising:
a communication unit that performs wireless communication with the network-based data warehouse system:
a driving context collection unit that collects driving context data items sensed from at least one first device of the vehicle, which is pre-designated to infer a situation related to the driving of the vehicle;
a driving situation context collection unit that collects driving situation context data items sensed from at least one second device of the vehicle, which is pre-designated to infer a background situation in which the vehicle is driven:
a driving action collection unit that collects driving action data items sensed from at least one third device of the vehicle, which is pre-designated to infer a driving action of a driver driving the vehicle; and
a processor that controls the communication unit to transmit sensor data including the driving context data, the driving situation context data and the driving action data to the network-based data warehouse system, and
wherein the processor further configured to:
determine a risk event corresponding to an event zone, which is a time section in which sensor data is detected, based on a preset risk event occurrence condition;
classify a background situation in which the vehicle is driven based on the driving situation context data into one of a plurality of preset driving situations;
detect at least one driving characteristic of a driver driving the vehicle based on the driving action data items, and classify the driver's driving style into one of a plurality of preset driving styles based on the detected driving characteristic; and
classify a driver's situational driving style corresponding to the sensor data based on the classified driving situation and driving style, and transmit the identification information of the classified driver's situational driving style the network-based data warehouse system, and
wherein the network-based data warehouse system is configured to:
rescore an event score of the each risk event based on at least one context matching the each risk event; and
calculate a driving score related to the driving of the vehicle based on a base score determined according to the driver's situational driving style corresponding to the received identification information, and the rescored event scores of the respective risk events.

16. The device of claim 15, wherein the at least one first device, the at least one second device and the at least one third device overlap one another at least partially.

17. The device of claim 15, wherein the processor is configured to:
extract context data items related to a driving situation of the vehicle from each time section of the sensor data corresponding to each event zone and a time section including predetermined periods of time before and after the each event zone, and determine a context representing a driving situation of the vehicle matching the each event zone based on the extracted context data items; and
match each risk event with at least one context based on a risk event and a context determined from each event zone, and transmit the matching result to the network-based data warehouse system.

18. (canceled)
